(19) United States
(12) Patent Application Publication
(10) Pub. No.: US 2020/0330933 A1
(43) Pub. Date: Oct. 22, 2020

(54) AERATOR

(71) Applicant: NANO-SCIENCE LABORATORY CORPORATION, Kyoto-shi (JP)

(72) Inventors: Yuji FUJITA, Kyoto-shi (JP); Masafumi KOBAYASHI, Kyoto-shi (JP); Masayuki SHIMADA, Kyoto-shi (JP); Tsuyoshi KIRIISHI, Kyoto-shi (JP)

(73) Assignee: NANO-SCIENCE LABORATORY CORPORATION, Kyoto-shi (JP)

(21) Appl. No.: 16/682,455

(22) Filed: Nov. 13, 2019

(30) Foreign Application Priority Data
Apr. 19, 2019 (JP) 2019-080209

(51) Int. Cl. B01F 3/04

(52) U.S. Cl. CPC B01F 3/04262; B01F 2215/0431; B01F 2003/04411; B01F 2003/04319

(57) ABSTRACT

An aerator includes an air supply chamber into which air is supplied by an air supply pump, a water flow channel connected to a water feed pipe, and a gas-permeable porous body having multiple gas discharge pores and separating the air supply chamber and the water flow channel. Air in the air supply chamber is pushed into water in the water flow channel through the gas discharge pores of the porous body due to discharge pressure of the air supply pump. In the porous body, inner surfaces of the gas discharge pores are coated with a coating film made of a water repellent having such a wettability that a water droplet contact angle is 80 degrees or more and preferably 90 degrees or more, on a smooth flat film surface.

### BACKGROUND OF THE INVENTION

### Field of the Invention

The present invention relates to an aerator, having multiple gas discharge pores, for use in a fine bubble generating apparatus that generates fine bubbles in water, and, in particular, to an aerator capable of inhibiting water from entering the gas discharge pores.

### Description of the Background Art

For example, Japanese Patent No. 6039139 describes a fine bubble generating apparatus that generates fine-bubbles-containing water. As illustrated in FIG. 6, this fine bubble generating apparatus includes a storage tank 51 that stores water, an aerator 52 immersed in the water stored in the storage tank 51, gas supply means 53 for supplying gas to the aerator 52, and vibration applying means 54 for applying vibration to the aerator 52. While vibration is continuously applied to the aerator 52 immersed in the water, the gas is discharged from the aerator 52 into the liquid. Thus, the gas is discharged from the aerator 52 into the water while being divided into fine bubbles through a predetermined vibration applied to the aerator 52, and the fine bubbles slowly contract while undergoing Brownian motion, to stably stay in the water as nanosized fine bubbles.

The aerator 52 has, for example, a hollow-rod-shaped member, with a closed end, which is formed from an air-permeable porous body made of ceramics or the like, and has multiple gas discharge pores, having a pore diameter of 2.5 um or less, which connect between the hollow portion and the outside. Thus, when gas is supplied at a predetermined pressure into the hollow portion of the aerator 52, the gas is discharged into the water through the gas discharge pores.

However, in the fine bubble generating apparatus as described above, when the supply of gas to the aerator 52 is temporarily stopped, water enters the gas discharge pores of the aerator 52 due to water pressure and capillary phenomenon, and the gas discharge pores are clogged with the water. Therefore, when the supply of gas to the aerator 52 is thereafter restarted, the gas may not be discharged into the water through the gas discharge pores.

Accordingly, when the supply of gas to the aerator 52 is restarted, a bothersome pretreatment needs to be performed such that, first, the pressure for supplying the gas to the aerator 52 is gradually increased to expel the water from the clogged gas discharge pores and open the gas discharge pores, and, then, the supply of gas is further continued to gradually discharge the water adhered to inner surfaces of the gas discharge pores. Therefore, considerable labor and time are required for the pretreatment in order to assuredly obtain an amount of discharged gas that is almost equivalent to the amount of discharged gas at the time of a steady-state operation before the stop of the supply of gas.

### SUMMARY OF THE INVENTION

Thus, an object of the present invention is to provide an aerator that, even when supply of gas to a fine bubble generating apparatus is temporarily stopped, allows supply of gas to be restarted in a short time without much labor and time for a pretreatment.

To attain the object mentioned above, an invention according to a first aspect provides an aerator which is used to generate fine bubbles in water and discharges gas into the water through a porous body having multiple gas discharge pores with a pore diameter (mode diameter) of 1.5 um or less, and the porous body is made of a material having such a wettability that a water droplet contact angle is 80 degrees or more on a smooth flat surface.

In an invention according to a second aspect, in the aerator of the first aspect, the porous body is made of a material having such a wettability that a water droplet contact angle is 90 degrees or more on a smooth flat surface.

An invention according to a third aspect is directed to an aerator which is used to generate fine bubbles in water and discharges gas into the water through a porous body having multiple gas discharge pores with a pore diameter (mode diameter) of 1.5 um or less, and, in the porous body, inner surfaces of the gas discharge pores are coated with a coating film, and the coating film is made of a water repellent having such a wettability that a water droplet contact angle is 80 degrees or more on a smooth flat film surface.

In an invention according to a fourth aspect, in the aerator of the third aspect, the coating film is made of a water repellent having such a wettability that a water droplet contact angle is 90 degrees or more on a smooth flat film surface.

In an invention according to a fifth aspect, in the aerator of the third or the fourth aspects, the film thickness of the coating film is 20% or less of the pore diameter of the gas discharge pore.

In an invention according to a sixth aspect, in the aerator of one of the third to the fifth aspects, the coating film is made of a silica-based water repellent that contains silica microparticles having a primary particle diameter of 10 nm or less.

In an invention according to a seventh aspect, in the aerator of any one of the first to the sixth aspects, the pore diameter (mode diameter) of the gas discharge pore is 0.6 um or less, and a pore diameter distribution of the gas discharge pores satisfies (D90-D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

The aerator according to the first aspect of the present invention is capable of generating nano-order fine bubbles since the gas discharge pores thereof have a pore diameter (mode diameter) of 1.5 μm or less as described above. In addition, since the porous body is made of a material having such a wettability that a water droplet contact angle is 80 degrees or more on a smooth flat surface, water does not easily enter the gas discharge pores of the aerator, and the gas discharge pores are not easily clogged with the water if supply of gas to the aerator is temporarily stopped. Accordingly, in a pretreatment to be performed when the supply of gas to the aerator is restarted, the gas discharge pores can be opened without significantly increasing the pressure for supplying gas, and water adhered to inner surfaces of the gas discharge pores can be almost entirely discharged without passing gas for a long time after the gas discharge pores are opened, thereby ensuring that an amount of discharged gas can be made almost equivalent to the amount of discharged gas at the time of a steady-state operation, in a short time.

In particular, in the aerator according to the second aspect of the present invention, the porous body is made of a material having such a wettability that a water droplet contact angle is 90 degrees or more on a smooth flat surface. Therefore, also when the supply of gas to the aerator is stopped, water is less likely to enter the gas discharge pores of the aerator, and an amount of water which is adhered to the inner surfaces of the gas discharge pores after the opening of the gas discharge pores is reduced, thereby ensuring that an amount of discharged gas can be made equivalent to the amount of discharged gas at the time of the steady-state operation, in a shorter time.

Similarly to the aerator according to the first aspect of the present invention, the aerator according to the third aspect of the present invention is capable of generating nano-order fine bubbles since the gas discharge pores thereof have a pore diameter (mode diameter) of 1.5 um or less. In addition, since, in the porous body, the inner surfaces of the gas discharge pores are coated with a coating film made of a water repellent having such a wettability that a water droplet contact angle is 80 degrees or more on a smooth flat film surface, water does not easily enter the gas discharge pores of the aerator, and the gas discharge pores are not easily clogged with the water also when the supply of gas to the aerator is temporarily stopped, as in the aerator according to the first aspect of the present invention. Accordingly, in a pretreatment to be performed when the supply of gas to the aerator is restarted, the gas discharge pores can be opened without significantly increasing the pressure for supplying gas, and water adhered to inner surfaces of the gas discharge pores can be almost entirely discharged without passing gas for a long time after the gas discharge pores are opened, thereby ensuring that an amount of discharged gas can be made almost equivalent to the amount of discharged gas at the time of a steady-state operation, in a short time.

In particular, in the aerator according to the fourth aspect of the present invention , the coating film has such a wettability that a water droplet contact angle is 90 degrees or more on a smooth flat film surface. Therefore, also when the supply of gas to the aerator is stopped, water are less likely to enter the gas discharge pores of the aerator, and an amount of water which is adhered to the inner surfaces of the gas discharge pores after the opening of the gas discharge pores is reduced, thereby ensuring that an amount of discharged gas can be made equivalent to the amount of discharged gas at the time of the steady-state operation, in a shorter time.

In the aerator according to the fifth aspect of the present invention, the film thickness of the coating film is 20% or less of the pore diameter of the gas discharge pores. Therefore, the pretreatment is not hindered when the supply of gas to the aerator is restarted.

In the aerator according to the sixth aspect of the present invention, the coating film is made of a silica-based water repellent that contains silica microparticles having a primary particle diameter of 10 nm or less, and, therefore, this coating film allows reduction of the film thickness and improvement of adhesion to the inner surfaces of the gas discharge pores.

In the aerator according to the seventh aspect of the present invention, the gas discharge pores have the pore diameter (mode diameter) of 0.6 μm or less, and variation in pore diameter is small such that the pore diameter distribution satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.. Therefore, a large amount of nano-order fine bubbles which have small bubble diameters and in which variation in bubble diameter is small, can be generated.

### BRIEF DESCRIPTION OF THE DRAWINGS

FIG. 1 is a diagram illustrating a schematic configuration of a fine bubble generating apparatus including an aerator according to an embodiment of the present invention;

FIG. 2 is a diagram illustrating a schematic configuration of an experimental apparatus for a verification experiment concerning workability in a pretreatment with respect to a porous body of the aerator;

FIG. 3 is a schematic diagram illustrating an aerator according to another embodiment of the present invention;

FIG. 4 is a schematic diagram illustrating an aerator according to another embodiment of the present invention;

FIG. 5 is a schematic diagram illustrating an aerator according to another embodiment of the present invention; and

FIG. 6 is a diagram illustrating a schematic configuration of an example of a fine bubble generating apparatus.

### DESCRIPTION OF THE PREFERRED EMBODIMENTS

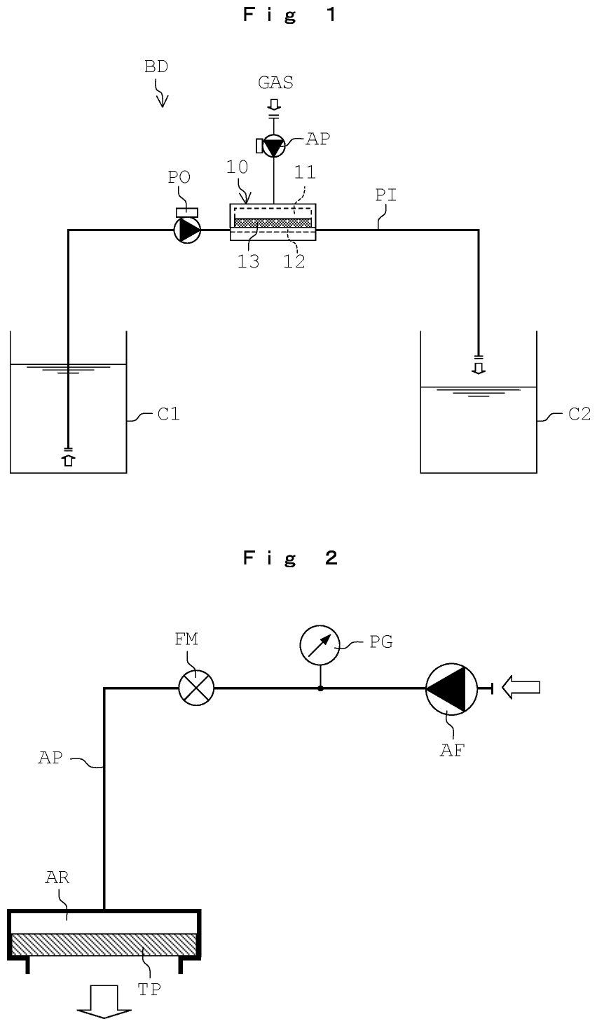

Hereinafter, embodiments of the present invention will be described with reference to the accompanying drawings. FIG. 1 illustrates a schematic configuration of a fine bubble generating apparatus including an aerator of the present invention. As illustrated in FIG. 1, a fine bubble generating apparatus BD includes a water tank C1 that stores liquid, a water feed pipe PI and a water feed pump PO for suctioning and feeding water stored in the water tank C1, an aerator 10 that discharges gas into the water being fed by the water feed pump PO, and a water tank C2 that stores the water into which the gas has been discharged by the aerator 10.

The aerator 10 includes an air supply chamber 11 into which air is supplied by an air supply pump AP, a water flow channel 12 connected to the water feed pipe PI, and a gas-permeable porous body 13 having multiple gas discharge pores and separating the air supply chamber 11 and the water flow channel 12 from each other. The aerator 10 is configured to push out the air in the air supply chamber 11 into the water in the water flow channel 12 through the gas discharge pores of the porous body 13 due to the discharge pressure of the air supply pump AP.

Accordingly, when the water feed pump PO and the air supply pump AP operate, the water in the water tank C1 is fed into the water flow channel 12 of the aerator 10, and air is pushed, due to the discharge pressure of the air supply pump AP, into the water passing through the water flow channel 12, from the gas discharge pores which are open in a lower surface of the porous body 13. The air thus pushed out from the gas discharge pores is divided into fine bubbles each of which is 1.5 μm or less in size by water current flowing in the water flow channel 12, and these fine bubbles slowly contract to generate nano-order fine bubbles, so that fine-bubbles-containing water that includes nano-order fine bubbles is stored in the water tank C2.

As the porous body 13 of the aerator 10, a porous body made of ceramics, carbon, glass, a synthetic resin, or the like and having gas discharge pores with a pore diameter (mode diameter) of 1.5 μm or less can be used, and inner surfaces of the gas discharge pores need to have at least a certain degree of water repellency (hydrophobicity). Specifically, it is necessary that the porous body 13 is made of a material having such a wettability that a water droplet contact angle is 80 degrees or more and preferably 90 degrees or more on a smooth flat surface, or that the inner surfaces of the gas discharge pores are coated with a coating film made of a water repellent having such a wettability that a water droplet contact angle is 80 degrees or more and preferably 90 degrees or more on a smooth flat film surface.

As the water repellent, a silicon-based silane compound water repellent, a fluororesin water repellent, a nano-silica-based water repellent, or the like can be used. In particular, using a nano-silica-based water repellent containing silica microparticles having a primary particle diameter of 10 nm or less to form the coating film is advantageous in that the film thickness is reduced and adhesion to the inner surfaces of the gas discharge pores is improved. The film thickness of the coating film made of the water repellent is preferably 20% or less of the pore diameter of the gas discharge pore.

When the operation of the fine bubble generating apparatus BD is stopped, that is, when the operations of the water feed pump PO and the air supply pump AP are stopped, the water in the water flow channel 12 enters the gas discharge pores of the porous body 13 due to capillary phenomenon. Therefore, when the operation of the fine bubble generating apparatus BD is restarted, a pretreatment needs to be performed such that, in a state where the operation of the water feed pump PO is stopped, the air supply pump AP is first operated and air is expelled into the water flow channel 12 to expel water from clogged gas discharge pores and open the gas discharge pores, and, then, air is continuously pushed into the water flow channel 12 to discharge water adhered to the inner surfaces of the gas discharge pores. Verification experiments concerning workability in the pretreatment were performed with respect to porous bodies according to examples 1 to 11 and comparative examples 1 to 12 as described below.

### EXAMPLE 1

As indicated in Table 1, a porous carbon material having gas discharge pores with a pore diameter (mode diameter) of 1.5 μm and the pore diameter distribution (D90−D10)/D50 (where D10, D50, and D90 represent the diameters of pores with which the cumulative number of pores counted from the smaller diameter side corresponds to 10%, 50%, and 90%, respectively, of the total number of pores) of 2.898 was cut so as to have an area of 250 mm² and a thickness of 5 mm, and was immersed in undiluted solution of a silicon-based silane compound water repellent (AQUASEAL 200S, produced by Nippon Paint Co., Ltd.) for five minutes or longer. Then, the carbon material was taken out, and an air pressure was applied thereto from one of the surfaces for several minutes to push out and remove a surplus water repellent from the gas discharge pores, and the resultant carbon material in this state was dried for one hour at 60° C. using a constant-temperature drying oven (DS401, produced by Yamato Scientific Co., Ltd.), thereby preparing a test sample having inner surfaces, of the gas discharge pores, coated with a coating film made of the water repellent. A smooth glass plate surface was coated with the silicon-based silane compound water repellent (undiluted solution) used above, and a water droplet having a weight of about 0.05 mg was dropped onto a surface of the resultant coating film. Then, the static contact angle was measured as 80 degrees in a drop method.

### EXAMPLE 2

As indicated in Table 1, a test sample was prepared in the same manner as in example 1 except that undiluted solution of a fluororesin water repellent (glaco, produced by Soft99 corporation) was used as the water repellent in place of the undiluted solution of the silicon-based silane compound water repellent (AQUASEAL 200S, produced by Nippon Paint Co., Ltd.). A smooth glass plate surface was coated with the fluororesin water repellent (undiluted solution) used above, and a water droplet having a weight of about 0.05 mg was dropped onto a surface of the resultant coating film. Then, the static contact angle was measured as 83 degrees in the drop method.

### EXAMPLE 3

As indicated in Table 1, a test sample was prepared in the same manner as in example 1 except that undiluted solution of a nano-silica-based water repellent (Nano Silica Coat HS-01, produced by Japan Nano Coat Co., Ltd.) was used as the water repellent in place of the undiluted solution of the silicon-based silane compound water repellent (AQUASEAL 200S, produced by Nippon Paint Co., Ltd.). A smooth glass plate surface was coated with the nano-silica-based water repellent (undiluted solution) used above, and a water droplet having a weight of about 0.05 mg was dropped onto a surface of the resultant coating film. Then, the static contact angle was measured as 92 degrees in the drop method.

### EXAMPLE 4

As indicated in Table 1, a test sample was prepared in the same manner as in example 1 except that a porous carbon material having gas discharge pores with a pore diameter (mode diameter) of 0.6 μm and the pore diameter distribution (D90−D10)/D50 of 2.015 was used in place of the porous carbon material having the gas discharge pores with a pore diameter (mode diameter) of 1.5 μm and the pore diameter distribution (D90−D10)/D50 of 2.898.

### EXAMPLE 5

As indicated in Table 1, a test sample was prepared in the same manner as in example 2 except that a porous carbon material having gas discharge pores with a pore diameter (mode diameter) of 0.6 μm and the pore diameter distribution (D90−D10)/D50 of 2.015 was used in place of the porous carbon material having the gas discharge pores with a pore diameter (mode diameter) of 1.5 μm and the pore diameter distribution (D90−D10)/D50 of 2.898.

### EXAMPLE 6

As indicated in Table 1, a test sample was prepared in the same manner as in example 3 except that a porous carbon material having gas discharge pores with a pore diameter (mode diameter) of 0.6 μm and the pore diameter distribution (D90−D10)/D50 of 2.015 was used in place of the porous carbon material having the gas discharge pores with a pore diameter (mode diameter) of 1.5 μm and the pore diameter distribution (D90−D10)/D50 of 2.898.

### EXAMPLE 7

As indicated in Table 1, a test sample was prepared in the same manner as in example 1 except that porous glass having gas discharge pores with a pore diameter (mode diameter) of 0.05 μm and the pore diameter distribution (D90−D10)/D50 of 1.206 was used in place of the porous carbon material having the gas discharge pores with a pore diameter (mode diameter) of 1.5 μm and the pore diameter distribution (D90−D10)/D50 of 2.898.

### EXAMPLE 8

As indicated in Table 1, a test sample was prepared in the same manner as in example 2 except that porous glass having gas discharge pores with a pore diameter (mode diameter) of 0.05 μm and the pore diameter distribution (D90−D10)/D50 of 1.206 was used in place of the porous carbon material having the gas discharge pores with a pore diameter (mode diameter) of 1.5 μm and the pore diameter distribution (D90−D10)/D50 of 2.898.

### EXAMPLE 9

As indicated in Table 1, a test sample was prepared in the same manner as in example 3 except that porous glass having gas discharge pores with a pore diameter (mode diameter) of 0.05 μm and the pore diameter distribution (D90−D10)/D50 of 1.206 was used in place of the porous carbon material having the gas discharge pores with a pore diameter (mode diameter) of 1.5 μm and the pore diameter distribution (D90−D10)/D50 of 2.898.

### EXAMPLE 10

As indicated in Table 1, a test sample was prepared by cutting porous polypropylene material having gas discharge pores with a pore diameter (mode diameter) of 1.5 um and the pore diameter distribution (D90−D10)/D50 of 2.962 so as to have an area of 250 mm² and a thickness of 5 mm. A water droplet having a weight of about 0.05 mg was dropped onto a surface of a smooth plate made of the same material as the test sample. Then, the static contact angle was measured as 87 degrees in the drop method.

### EXAMPLE 11

As indicated in Table 1, a test sample was prepared by cutting a porous fluororesin (polytetrafluoroethylene) having gas discharge pores with a pore diameter (mode diameter) of 1.5 um and the pore diameter distribution (D90−D10)/D50 of 2.931 so as to have an area of 250 mm² and a thickness of 5 mm. A water droplet having a weight of about 0.05 mg was dropped onto a surface of a smooth plate made of the same material as the test sample. Then, the static contact angle was measured as 114 degrees in the drop method.

### COMPARATIVE EXAMPLE 1

As indicated in Table 1, a test sample was prepared in the same manner as in example 1 except that, in place of the undiluted solution of the silicon-based silane compound water repellent (AQUASEAL 200S, produced by Nippon Paint Co., Ltd.), a tenfold dilution thereof was used as the water repellent. A smooth glass plate surface was coated with the tenfold dilution of the silicon-based silane compound water repellent used above, and a water droplet having a weight of about 0.05 mg was dropped onto a surface of the resultant coating film. Then, the static contact angle was measured as 32 degrees in the drop method.

### COMPARATIVE EXAMPLE 2

As indicated in Table 1, a test sample was prepared in the same manner as in example 2 except that, in place of the undiluted solution of the fluororesin water repellent (glaco, produced by Soft99 corporation), a tenfold dilution thereof was used as the water repellent. A smooth glass plate surface was coated with the tenfold dilution of the fluororesin water repellent used above, and a water droplet having a weight of about 0.05 mg was dropped onto a surface of the resultant coating film. Then, the static contact angle was measured as 28 degrees in the drop method.

### COMPARATIVE EXAMPLE 3

As indicated in Table 1, a test sample was prepared in the same manner as in example 3 except that, in place of the undiluted solution of the nano-silica-based water repellent (Nano Silica Coat HS-01, produced by Japan Nano Coat Co., Ltd.), a tenfold dilution thereof was used as the water repellent. A smooth glass plate surface was coated with the tenfold dilution of the nano-silica-based water repellent used above, and a water droplet having a weight of about 0.05 mg was dropped onto a surface of the resultant coating film. Then, the static contact angle was measured as 35 degrees in the drop method.

### COMPARATIVE EXAMPLE 4

As indicated in Table 1, a test sample was prepared in the same manner as in example 1 except that the coating using a water repellent was not performed. A water droplet having a weight of about 0.05 mg was dropped onto a surface of a smooth plate made of the same material as the test sample. Then, the static contact angle was measured as 56 degrees in the drop method.

### COMPARATIVE EXAMPLE 5

As indicated in Table 1, a test sample was prepared in the same manner as in example 4 except that, in place of the undiluted solution of the silicon-based silane compound water repellent (AQUASEAL 200S, produced by Nippon Paint Co., Ltd.), a tenfold dilution thereof was used as the water repellent.

### COMPARATIVE EXAMPLE 6

As indicated in Table 1, a test sample was prepared in the same manner as in example 5 except that, in place of the undiluted solution of the fluororesin water repellent (glaco, produced by Soft99 corporation), a tenfold dilution thereof was used as the water repellent.

### COMPARATIVE EXAMPLE 7

As indicated in Table 1, a test sample was prepared in the same manner as in example 6 except that, in place of the undiluted solution of the nano-silica-based water repellent (Nano Silica Coat HS-01, produced by Japan Nano Coat Co., Ltd.), a tenfold dilution thereof was used as the water repellent.

### COMPARATIVE EXAMPLE 8

As indicated in Table 1, a test sample was prepared in the same manner as in example 4 except that the coating using a water repellent was not performed. A water droplet having a weight of about 0.05 mg was dropped onto a surface of a smooth plate made of the same material as the test sample. Then, the static contact angle was measured as 56 degrees in the drop method.

### COMPARATIVE EXAMPLE 9

As indicated in Table 1, a test sample was prepared in the same manner as in example 7 except that, in place of the undiluted solution of the silicon-based silane compound water repellent (AQUASEAL 200S, produced by Nippon Paint Co., Ltd.), a tenfold dilution thereof was used as the water repellent.

### COMPARATIVE EXAMPLE 10

As indicated in Table 1, a test sample was prepared in the same manner as in example 8 except that, in place of the undiluted solution of the fluororesin water repellent (glaco, produced by Soft99 corporation), a tenfold dilution thereof was used as the water repellent.

### COMPARATIVE EXAMPLE 11

As indicated in Table 1, a test sample was prepared in the same manner as in example 9 except that, in place of the undiluted solution of the nano-silica-based water repellent (Nano Silica Coat HS-01, produced by Japan Nano Coat Co., Ltd.), a tenfold dilution thereof was used as the water repellent.

### COMPARATIVE EXAMPLE 12

As indicated in Table 1, a test sample was prepared in the same manner as in example 7 except that the coating using a water repellent was not performed. A water droplet having a weight of about 0.05 mg was dropped onto a surface of a smooth plate made of the same material as the test sample. Then, the static contact angle was measured as 23 degrees in the drop method.

TABLE 1

| | Porous Body | | | | | |
|---|---|---|---|---|---|---|
| | | Pore | Pore | | | |
| | | Diameter | Diameter | | | |
| | | (Mode | (D90- | | | Contact |
| | | Diameter) | D10)/D50 | Water Repellent | | Angle |
| | Material | [μm] | [−] | Type | Concentration | [Degrees] |
| Example 1 | Carbon | 1.5 | 2.898 | Silicon-based Silane | Undiluted | 80 |
| | | | | Compound Water Repellent | Solution | |
| Example 2 | Carbon | 1.5 | 2.898 | Fluororesin | Undiluted | 83 |
| | | | | Water Repellent | Solution | |
| Example 3 | Carbon | 1.5 | 2.898 | Nano-silica-based | Undiluted | 92 |
| | | | | Water Repellent | Solution | |
| Example 4 | Carbon | 0.6 | 2.015 | Silicon-based Silane | Undiluted | 80 |
| | | | | Compound Water Repellent | Solution | |
| Example 5 | Carbon | 0.6 | 2.015 | Fluororesin | Undiluted | 83 |
| | | | | Water Repellent | Solution | |
| Example 6 | Carbon | 0.6 | 2.015 | Nano-silica-based | Undiluted | 92 |
| | | | | Water Repellent | Solution | |
| Example 7 | Glass | 0.05 | 1.206 | Silicon-based Silane | Undiluted | 80 |
| | | | | Compound Water Repellent | Solution | |
| Example 8 | Glass | 0.05 | 1.206 | Fluororesin | Undiluted | 83 |
| | | | | Water Repellent | Solution | |
| Example 9 | Glass | 0.05 | 1.206 | Nano-silica-based | Undiluted | 92 |
| | | | | Water Repellent | Solution | |
| Example 10 | Polypropylene | 1.5 | 2.962 | None | | 87 |
| Example 11 | Fluororesin | 1.5 | 2.931 | None | | 114 |
| Comparative | Carbon | 1.5 | 2.898 | Silicon-based Silane | Tenfold | 32 |
| Example 1 | | | | Compound Water Repellent | Dilution | |
| Comparative | Carbon | 1.5 | 2.898 | Fluororesin | Tenfold | 28 |
| Example 2 | | | | Water Repellent | Dilution | |
| Comparative | Carbon | 1.5 | 2.898 | Nano-silica-based | Tenfold | 35 |
| Example 3 | | | | Water Repellent | Dilution | |
| Comparative | Carbon | 1.5 | 2.898 | None | | 56 |
| Example 4 | | | | | | |
| Comparative | Carbon | 0.6 | 2.015 | Silicon-based Silane | Tenfold | 32 |
| Example 5 | | | | Compound Water Repellent | Dilution | |
| Comparative | Carbon | 0.6 | 2.015 | Fluororesin | Tenfold | 28 |
| Example 6 | | | | Water Repellent | Dilution | |
| Comparative | Carbon | 0.6 | 2.015 | Nano-silica-based | Tenfold | 35 |
| Example 7 | | | | Water Repellent | Dilution | |
| Comparative | Carbon | 0.6 | 2.015 | None | | 56 |
| Example 8 | | | | | | |
| Comparative | Glass | 0.05 | 1.206 | Silicon-based Silane | Tenfold | 32 |
| Example 9 | | | | Compound Water Repellent | Dilution | |
| Comparative | Glass | 0.05 | 1.206 | Fluororesin | Tenfold | 28 |
| Example 10 | | | | Water Repellent | Dilution | |
| Comparative | Glass | 0.05 | 1.206 | Nano-silica-based | Tenfold | 35 |
| Example 11 | | | | Water Repellent | Dilution | |
| Comparative | Glass | 0.05 | 1.206 | None | | 23 |
| Example 12 | | | | | | |

(Experimental Apparatus)

As illustrated in FIG. 2, an experimental apparatus used for the verification experiments concerning the workability in the pretreatment includes an air supply chamber AR being open to the atmosphere through a test sample TP, an air supply pump AF and an air supply pipe AP for supplying air into the air supply chamber AR, and a flow meter FM and a pressure gauge PG disposed downstream of the air supply pump AF in the air supply pipe AP. The experimental apparatus is configured to be capable of measuring a supplied-air flow rate by the flow meter FM and an air supply pressure by the pressure gauge PG

The verification experiments were performed in the following manner, and obtained measurement data is indicated in Table 2.

(Experimental Method)

### <Measurement of Test Sample Before Water Permeation>

Each of the test samples TP of examples 1 to 11 and comparative examples 1 to 12 described above was set in the air supply chamber AR of the experimental apparatus, and the discharge pressure of the air supply pump AF was adjusted such that the pressure measured by the pressure gauge PG (air supply pressure) was 0.1 MPa. In this state, the air flow rate at this time was measured with the flow meter FM.

### <Preparation of Test Sample in Water Permeating State>

A water pressure was applied to one of surfaces of each test sample TP to cause water to enter the gas discharge pores, and the application of the pressure was stopped at a time when the water was pushed out through the other of the surfaces of the test sample TP. Then, the test sample TP was left as it was for ten minutes, so that a test sample having the gas discharge pores clogged with water was prepared.

### <Measurement of Test Sample After Water Permeation>

Each test sample TP having the gas discharge pores clogged with water was set in the air supply chamber AR, and the pressure in the air supply chamber AR was increased by supplying air into the air supply chamber AR at a rate of 100 cc/min by using the air supply pump AF. A maximum air supply pressure immediately before the gas discharge pores were opened as a result of the water in the gas discharge pores being pushed out was measured, and the air flow rate was then measured at a time when the pressure in the air supply chamber AR was reduced to 0.1 MPa.

TABLE 2

| | Before Water Permeation | After Water Permeation | | |
|---|---|---|---|---|
| | Air Flow Rate in the | Maximum Air Supply | Air Flow Rate in the | Reduction |
| | case of Air Supply | Pressure Immediately | case of Air Supply | Percentage |
| | Pressure being 0.1 MPa | before Air Discharge | Pressure being 0.1 MPa | of Air Flow |
| | [mL/min] | [MPa] | [mL/min] | Rate [%] |
| Example 1 | 100 | 1.5 | 97 | 3 |
| Example 2 | 100 | 1.0 | 98 | 2 |
| Example 3 | 100 | 0.5 | 99 | 1 |
| Example 4 | 100 | 1.9 | 96 | 4 |
| Example 5 | 100 | 1.5 | 94 | 6 |
| Example 6 | 100 | 0.8 | 97 | 3 |
| Example 7 | 50 | 3.0 | 47 | 6 |
| Example 8 | 50 | 2.8 | 45 | 10 |
| Example 9 | 50 | 2.1 | 48 | 4 |
| Example 10 | 100 | 1.0 | 98 | 2 |
| Example 11 | 100 | 0.1 | 100 | 0 |
| Comparative | 100 | 4.0 | 8 | 92 |
| Example 1 | | | | |
| Comparative | 100 | 4.5 | 10 | 90 |
| Example 2 | | | | |
| Comparative | 100 | 4.0 | 17 | 83 |
| Example 3 | | | | |
| Comparative | 100 | 5.5 | 5 | 95 |
| Example 4 | | | | |
| Comparative | 100 | 5.3 | 6 | 94 |
| Example 5 | | | | |
| Comparative | 100 | 5.1 | 8 | 92 |
| Example 6 | | | | |
| Comparative | 100 | 4.8 | 10 | 90 |
| Example 7 | | | | |
| Comparative | 100 | 7.2 | 4 | 96 |
| Example 8 | | | | |
| Comparative | 50 | 8.9 | 4 | 92 |
| Example 9 | | | | |
| Comparative | 50 | 8.5 | 5 | 90 |
| Example 10 | | | | |
| Comparative | 50 | 8.2 | 9 | 82 |
| Example 11 | | | | |
| Comparative | 50 | 9.0 | 2 | 96 |
| Example 12 | | | | |

As is apparent from Table 2, in the case of the test samples (porous bodies) of comparative examples 1 to 3, comparative examples 5 to 7, and comparative examples 9 to 11 in each of which the coating film of the inner surfaces of the gas discharge pores was made of the water repellent having such a wettability that a water droplet contact angle was less than 80 degrees (35 degrees or less) on the smooth flat film surface, and in the case of the test samples (porous bodies) of comparative examples 4, 8, and 12 each of which was made of the material having such a wettability that a water droplet contact angle was less than 80 degrees (56 degrees or less) on the smooth flat surface, the maximum air supply pressure immediately before air discharge was in the range of 4.0 to 9.0 MPa, meaning that the air supply pressure was required to be significantly increased for opening the gas discharge pores clogged with water, and, therefore, a time required for increasing the air supply pressure was elongated, and the gas discharge pores clogged with water were not able to be opened in a short time. Meanwhile, in the case of the test samples (porous bodies) of examples 1 to 9 in each of which the coating film of the inner surfaces of the gas discharge pores was made of the water repellent having such a wettability that a water droplet contact angle was 80 degrees or more on the smooth flat film surface, and in the case of the test samples (porous bodies) of examples 10 and 11 each of which was made of the material having such a wettability that a water droplet contact angle was 80 degrees or more on the smooth flat surface, the maximum air supply pressure immediately before air discharge was 3.0 MPa or less, meaning that the air supply pressure were not required to be significantly increased for opening the gas discharge pores clogged with water, and, therefore, a time required for increasing the air supply pressure was able to shortened, and the gas discharge pores clogged with water were able to be opened in a short time.

In particular, in the case of the test samples (porous bodies) of examples 3, 6, and 9 in each of which the coating film of the inner surfaces of the gas discharge pores was made of the water repellent having such a wettability that a water droplet contact angle was 90 degrees or more on the smooth flat film surface, the maximum air supply pressure immediately before air discharge was lower and the gas discharge pores was able to be opened in a shorter time as compared with similar porous bodies (which were the same in the material, the pore diameter (mode diameter), and the pore diameter distribution) on each of which a coating film having such a wettability that a water droplet contact angle was less than 90 degrees on the smooth flat film surface was formed. In addition, in the case of the test sample (porous body) of example 11 which was made of the material having such a wettability that a water droplet contact angle was 90 degrees or more on the smooth flat surface, the maximum air supply pressure immediately before air discharge was lower and the gas discharge pores were able to be opened in a shorter time as compared with the test sample (porous body) of example 10 which was made of the material having such a wettability that a water droplet contact angle was less than 90 degrees on the smooth flat surface. Accordingly, in the case where the inner surfaces of the gas discharge pores are coated with the coating film, the coating film is preferably made of a water repellent having such a wettability that a water droplet contact angle is 90 degrees or more on a smooth flat film surface, whereas, in the case where the inner surfaces of the gas discharge pores are not coated with a coating film, the porous body itself is preferably made of a material having such a wettability that a water droplet contact angle is 90 degrees or more on a smooth flat surface.

In addition, as is apparent from Table 2, in the case of the test samples (porous bodies) of comparative examples 1 to 3, comparative examples 5 to 7, and comparative examples 9 to 11 in each of which the coating film of the inner surfaces of the gas discharge pores was made of the water repellent having such a wettability that a water droplet contact angle was less than 80 degrees (35 degrees or less) on the smooth flat film surface, and in the case of the test samples (porous bodies) of comparative examples 4, 8, and 12 each of which was made of the material having such a wettability that a water droplet contact angle was less than 80 degrees (56 degrees or less) on the smooth flat surface, the air flow rate in a state where the air supply pressure was reduced to 0.1 MPa after the gas discharge pores clogged with water were opened was considerably lower than the air flow rate at the time when the air supply pressure was 0.1 MPa before the clogging of the gas discharge pores with water (reduction percentage of the air flow rate was 82% to 96%). Meanwhile, in the case of the test samples (porous bodies) of examples 1 to 9 in each of which the coating film of the inner surfaces of the gas discharge pores was made of the water repellent having such a wettability that a water droplet contact angle was 80 degrees or more on the smooth flat film surface, and in the case of the test samples (porous bodies) of examples 10 and 11 each of which was made of the material having such a wettability that a water droplet contact angle was 80 degrees or more on the smooth flat surface, the air flow rate in a state where the air supply pressure was reduced to 0.1 MPa after the gas discharge pores clogged with water were opened was not considerably lower than the air flow rate at the time when the air supply pressure was 0.1 MPa before the clogging of the gas discharge pores with water (reduction percentage of the air flow rate was 0% to 10%), and was maintained to be almost equivalent to the air flow rate before the clogging of the gas discharge pores with water.

The air flow rate in a state where, after the clogged gas discharge pores are opened, the air supply pressure is reduced to a value at the time before the clogging of the gas discharge pores with water, is lower than the air flow rate before the clogging because water is adhered also to the inner surfaces of the opened gas discharge pores, and the adhered water increases the resistance of the gas discharge pores. It can be considered that, in the case of the test samples (porous bodies) of examples 1 to 11 in which reduction percentage of the air flow rate was low, an amount of water adhered to the inner surfaces of the opened gas discharge pores was less than in the case of the test samples (porous bodies) of comparative examples 1 to 12 in which reduction percentage of the air flow rate was high. Accordingly, when the coating film of the inner surfaces of the gas discharge pores is made of a water repellent having such a wettability that a water droplet contact angle is 80 degrees or more on a smooth flat film surface, or the porous body itself is made of a material having such a wettability that a water droplet contact angle is 80 degrees or more on a smooth flat surface, an amount of water adhered to the inner surfaces of the opened gas discharge pores is able to be reduced, and the water adhered to the inner surfaces of the gas discharge pores is able to be almost entirely discharged without passing air for a long time after the gas discharge pores are opened, thereby ensuring that an amount of discharged gas is made almost equivalent to an amount of discharged gas at the time of a steady-state operation, in a short time.

In particular, in the case of the test samples (porous bodies) of examples 3, 6, and 9 in each of which the coating film of the inner surfaces of the gas discharge pores was made of a water repellent having such a wettability that a water droplet contact angle was 90 degrees or more on a smooth flat film surface, reduction percentage of the air flow rate was lower, and a time for passing air for discharging the water adhered to the opened gas discharge pores was able to be made shorter as compared with similar porous bodies (which were the same in the material, the pore diameter (mode diameter), and the pore diameter distribution) on each of which a coating film having such a wettability that a water droplet contact angle was less than 90 degrees on a smooth flat film surface was formed. In addition, in the case of the test sample (porous body) of example 11 which was made of the material having such a wettability that a water droplet contact angle was 90 degrees or more on the smooth flat surface, reduction percentage of the air flow rate was lower, and a time for passing air for discharging the water adhered to the opened gas discharge pores was able to be made shorter as compared with the test sample (porous body) of example 10 which was made of the material having such a wettability that a water droplet contact angle was less than 90 degrees on the smooth flat surface. Accordingly, also from the viewpoint of reducing the time for passing air for discharging water adhered to the opened gas discharge pores, a coating film is preferably made of a water repellent having such a wettability that a water droplet contact angle is 90 degrees or more on a smooth flat film surface in the case where the inner surfaces of the gas discharge pores are coated with a coating film, whereas the porous body itself is preferably made of a material having such a wettability that a water droplet contact angle is 90 degrees or more on a smooth flat surface in the case where the inner surfaces of the gas discharge pores are not coated with a coating film.

In addition, in the case where, after the porous body is immersed in the water repellent, the porous body is dried in a state where a surplus water repellent has been pushed out and removed from the gas discharge pores by the application of an air pressure from one of the surfaces of the porous body as described above, the film thickness of the coating film of the water repellent with which the inner surfaces of the gas discharge pores are coated is able to be limited to 20% or less of the pore diameter of the gas discharge pore, and, therefore, even if the gas discharge pores of the porous body have small pore diameters, the pretreatment is not hindered when the supply of gas to the aerator is restarted.

In addition, the nano-silica-based water repellent (Nano Silica Coat HS-01, produced by Japan Nano Coat Co., Ltd.) used as the water repellent in examples 3, 6, and 9 contained silica microparticles having a primary particle diameter of 10 nm or less, and, therefore, the coating film made of this water repellent advantageously allowed reduction of the film thickness and improvement of adhesion to the inner surfaces of the gas discharge pores.

In addition, an aerator using each of the test samples (porous bodies) of examples 4 to 9 in each of which the gas discharge pore had a pore diameter (mode diameter) of 0.6 μm or less and variation in pore diameter was small such that the pore diameter distribution (D90−D10)/D50 was 3.0 or less, was able to generate a large amount of fine bubbles which had a bubble diameter of about 100 nm and in which variation in bubble diameter was small.

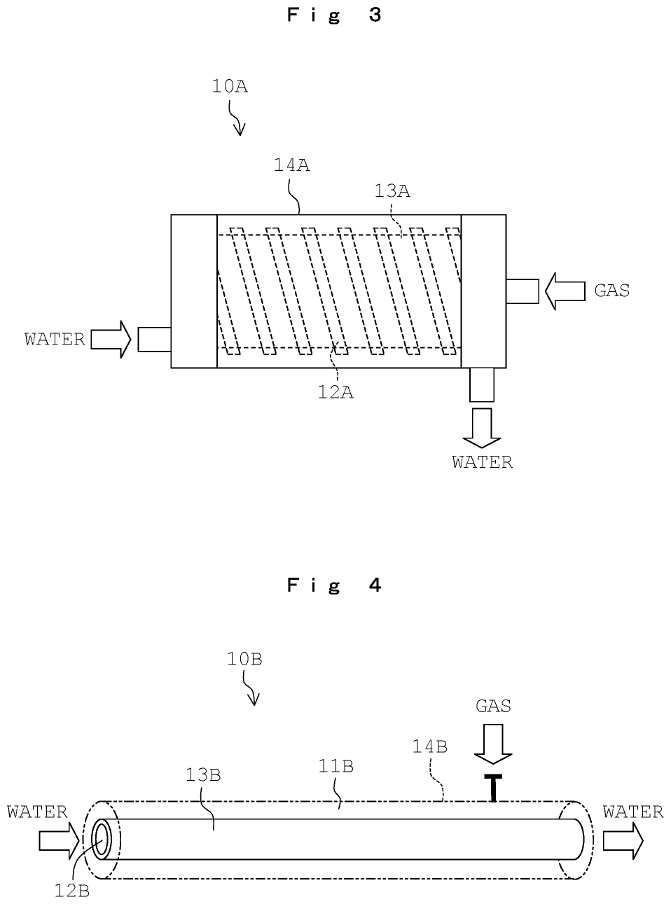

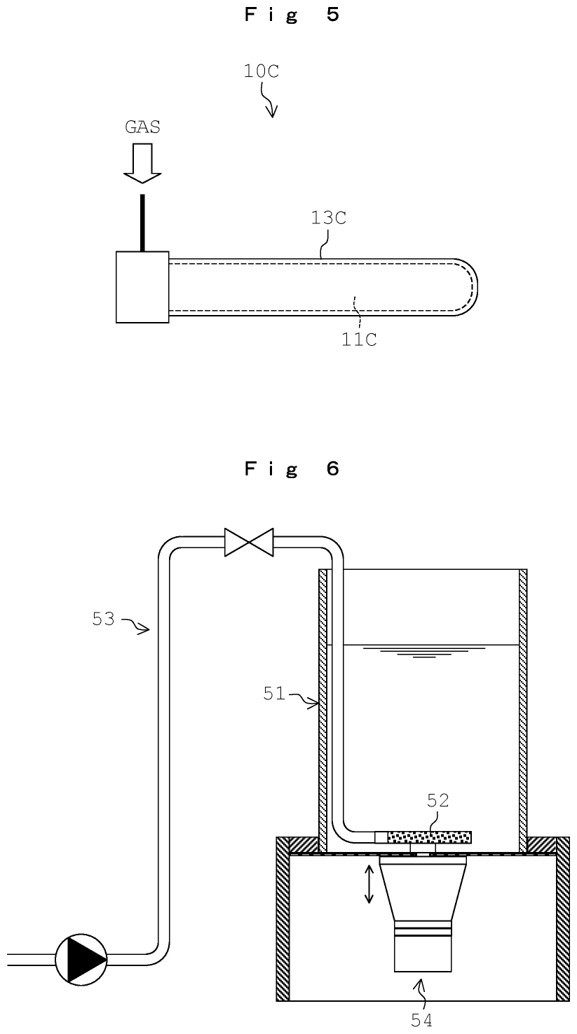

The aerator may have any configuration as long as the aerator is capable of discharging gas into water through a porous body. For example, an aerator 10A may be configured as illustrated in FIG. 3 such that both end portions of a cylindrical porous body 13A are closed, a hollow portion of the cylindrical porous body 13A serves as an air supply chamber into which gas is introduced, an outer circumferential portion of the porous body 13A is covered with a cylindrical body 14A having one helical groove formed in an inner circumferential surface, and a helical water flow channel 12A into which water is introduced is formed on the outer circumferential side of the porous body 13A. Meanwhile, an aerator 10B may be configured as illustrated in FIG. 4 such that a hollow portion of a cylindrical porous body 13B serves as a water flow channel 12B, an outer circumferential portion of the porous body 13B is covered with a cylindrical body 14B indicated by alternate long and two short dashes line in FIG. 4, and an air supply chamber 11B into which gas is introduced is thus formed on the outer circumferential side of the porous body 13B. An aerator 10C may be configured as illustrated in FIG. 5 such that a hollow portion of a cylindrical porous body 13C with a closed end serves as an air supply chamber 11C, and this aerator 10C is disposed in flowing water or in stationary water.

The aerator according to the present invention can be used in fine bubble generating apparatuses that generate nano-order fine bubbles in water.

1. An aerator which is used to generate fine bubbles in water and discharges gas into the water through a porous body having multiple gas discharge pores with a pore diameter (mode diameter) of 1.5 μm or less, wherein the porous body is made of a material having such a wettability that a water droplet contact angle is 80 degrees or more on a smooth flat surface.

2. The aerator according to claim 1, wherein the porous body is made of a material having such a wettability that a water droplet contact angle is 90 degrees or more on a smooth flat surface.

3. An aerator which is used to generate fine bubbles in water and discharges gas into the water through a porous body having multiple gas discharge pores with a pore diameter (mode diameter) of 1.5 μm or less, wherein in the porous body, inner surfaces of the gas discharge pores are coated with a coating film, and
the coating film is made of a water repellent having such a wettability that a water droplet contact angle is 80 degrees or more on a smooth flat film surface.

4. The aerator according to claim 3, wherein the coating film is made of a water repellent having such a wettability that a water droplet contact angle is 90 degrees or more on a smooth flat film surface.

5. The aerator according to claim 3, wherein a film thickness of the coating film is 20% or less of the pore diameter of the gas discharge pore.

6. The aerator according to claim 4, wherein a film thickness of the coating film is 20% or less of the pore diameter of the gas discharge pore.

7. The aerator according to claim 3, wherein the coating film is made of a silica-based water repellent that contains silica microparticles having a primary particle diameter of 10 nm or less.

8. The aerator according to claim 4, wherein the coating film is made of a silica-based water repellent that contains silica microparticles having a primary particle diameter of 10 nm or less.

9. The aerator according to claim 5, wherein the coating film is made of a silica-based water repellent that contains silica microparticles having a primary particle diameter of 10 nm or less.

10. The aerator according to claim 1, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

11. The aerator according to claim 2, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

12. The aerator according to claim 3, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

13. The aerator according to claim 4, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

14. The aerator according to claim 5, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.

15. The aerator according to claim 6, wherein
the pore diameter (mode diameter) of the gas discharge pore is 0.6 μm or less, and
a pore diameter distribution of the gas discharge pores satisfies (D90−D10)/D50≤3.0 where D10 represents a pore diameter with which a cumulative number of pores counted from a smaller diameter side corresponds to 10% of a total number of pores, D50 represents a pore diameter with which a cumulative number of pores counted from the smaller diameter side corresponds to 50% of the total number of pores, and D90 represents a pore diameter with which a cumulative number of pores counted from the smaller diameter side corresponds to 90% of the total number of pores.
